(19) United States
(12) Patent Application Publication
(10) Pub. No.: US 2019/0002040 A1
(43) Pub. Date: Jan. 3, 2019

(54) SPARE TIRE REMOVAL FEATURE, SYSTEM, AND METHOD

(71) Applicant: GM GLOBAL TECHNOLOGY OPERATIONS LLC, Detroit, MI (US)

(72) Inventors: Julio Cesar Carbajal Mendoza, Lerma (MX); Ana Carmen Camacho Rodriguez, Toluca (MX)

(21) Appl. No.: 15/635,593

(22) Filed: Jun. 28, 2017

(51) Int. Cl. B62D 43/00; B62D 43/10; B62D 25/08

(52) U.S. Cl. CPC B62D 43/002; B62D 25/087; B62D 43/10

(57) ABSTRACT

What is presented is a tire-removal feature configured to be located within a tire well, the tire well configured to contain a vehicle tire. The tire-removal feature includes a body having a first end and a second end. The first end is configured to be permanently fastened to a first portion of the tire well. The second end is configured to be releasably fastened to a second portion of the tire well. Moreover, the tire-removal feature is configured to substantially remove the vehicle tire from the tire well when the second end is released and extended away from the second portion of the tire well such that the body becomes substantially inflexible.

### INTRODUCTION

Having a flat tire can be a frustrating experience for those stranded in the vehicle. When such situations occur, the flat tire has to be removed from the vehicle's wheel and replaced with a spare tire. That said, for many, attaining the spare tire from the vehicle can be frustrating in itself. Not only does spare tire removal take an undesirable amount of effort, the tire's location in the vehicle can force unwanted strain on the removing person and increases their risk of injury. It is therefore desirable to reduce spare tire removal effort and injury risk.

### SUMMARY

What is presented is a tire-removal feature configured to be located within a tire well, the tire well configured to contain a vehicle tire. The tire-removal feature includes a body having a first end and a second end. The first end is configured to be permanently fastened to a first portion of the tire well. The second end is configured to be releasably fastened to a second portion of the tire well. Moreover, the tire-removal feature is configured to substantially remove the vehicle tire from the tire well when the second end is released and extended away from the second portion of the tire well such that the body becomes substantially inflexible.

The tire-removal feature may be configured to allow the vehicle tire to rest over the body when the second end is not being extended away from the second portion of the tire well. The body may be made from a flexible material. As follows, the body may be made from an elastomeric material, fabric, polyethylene, polypropylene, aluminum, copper, or some combination thereof. The application of body weight may facilitate the body to become substantially inflexible and the second end may include an opening configured to receive a foot. The second end may include a handle. The first end may be configured for a sill plate feature to permanently fasten the first end to the first portion of the tire well.

A vehicle tire removal system is also herein presented. The system includes: a tire well and tire-removal feature. The tire well is configured to contain the vehicle tire within a vehicle. The tire-removal feature is located within the tire well, wherein a first end of the body of the tire-removal feature is permanently fastened to a first portion of the tire well and the second end of the body is releasably fastened to a second portion of the tire well, and wherein the tire-removal feature is configured to substantially raise the vehicle tire from the tire well when the second end is released and extended away from the second portion of the tire well such that the body of the tire removal feature has become substantially inflexible.

The tire well may be located in the trunk of a vehicle. A sill plate feature may permanently fasten the first end of the body to the first portion of the tire well. The tire-removal feature may be configured to allow the vehicle tire to rest over the body when the second end is not being extended away from the second portion of the tire well. The body may be made from a flexible material. As follows, the body may be made from an elastomeric material, fabric, polyethylene, polypropylene, aluminum, copper, or some combination thereof. The second end may be extended away from the second portion of the tire well through the implementation of body weight and the second end may include an opening configured to receive a foot. The second end may include a handle.

A method of removing a tire from a tire well is also presented herein. The method includes the steps of: providing a tire well configured to contain a vehicle tire; providing a tire-removal feature configured to be located within the tire well, the tire-removal feature includes: a body having a first end and a second end; the first end permanently fastened to a first portion of the tire well; and the second end releasably fastened to a second portion of the tire well; releasing the second end from the second portion of the tire well; extending the second end away from the second portion of the tire well; permitting the body to become substantially inflexible by further extending the second end away from the first end; and allowing the vehicle tire to raise from the tire well while the body becomes substantially inflexible.

The method may further include the steps of: providing the vehicle tire configured to be contained in the tire well; and removing the raised vehicle tire from the tire well when the body has become substantially inflexible. The method may further include the step of allowing the vehicle tire to rest over the body when the second end is not being extended away from the second portion of the tire well. The application of body weight may facilitate the vehicle tire to raise from the tire well while the body becomes substantially inflexible and the second end may include an opening configured to receive a foot. The body may be made from an elastomeric material, fabric, polyethylene, polypropylene, aluminum, copper, or some combination thereof. The second end may include a handle. A sill plate feature may permanently fasten the first end of the body to the first portion of the tire well.

The above features and advantages and other features and advantages of the present teachings are readily apparent from the following detailed description for carrying out the teachings when taken in connection with the accompanying drawings.

### BRIEF DESCRIPTION OF THE DRAWINGS

FIG. 1 is a top-down view of a vehicle tire removal system according to an aspect of the present disclosure;

FIG. 2 is a side view of the removal system of FIG. 1;

FIG. 3 is side view of the removal system of FIG. 1 according to another aspect of the present disclosure;

FIG. 4 is a perspective view of the removal system of FIG. 1 according to the aspect shown in FIG. 3;

FIG. 5 is a perspective view of another embodiment of the vehicle tire removal system according to an aspect of the present disclosure;

FIG. 6A represents one or more steps of removing a tire implementing the tire removal system of FIG. 1 according to an aspect of the present disclosure;

FIG. 6B represents one or more additional steps of removing a tire implementing the tire removal system of FIG. 1 according to an aspect of the present disclosure; and

FIG. 6C represents one or more steps of removing a tire implementing the tire removal system of FIG. 5 according to an aspect of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

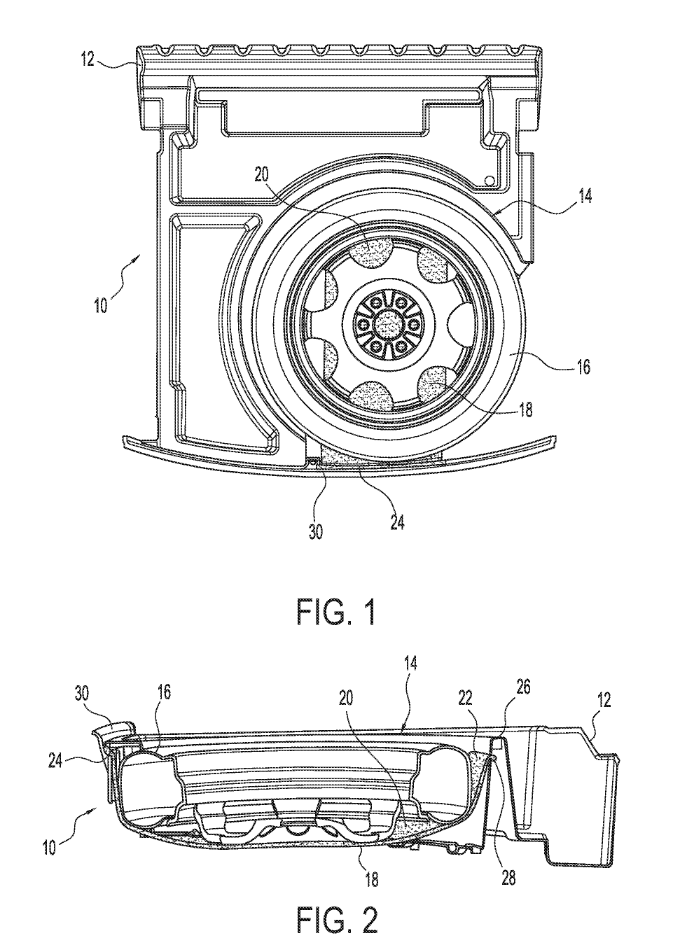

FIGS. 1 and 2 illustrate a vehicle tire removal system 10 that may be located in the trunk 12 of a vehicle. System 10 includes a tire well 14 and tire-removal feature 18. Well 14 is sufficiently deep so as to contain a vehicle tire 16 within trunk 12 while without generally impeding upon the remaining trunk space above well 14. When tire 16 is properly placed within well 14, moreover, the tire 16 rests over a tire-removal feature 18, which can be made of flexible material such as, but not limited to, an elastomeric material, fabric, polyethylene, polypropylene, aluminum, or copper (or feature 18 could be made from some combination of these materials). Skilled artisans will see that chassis tools, for flat tire repair may also rest over feature 18 in addition to or instead of tire 16.

Tire-removal feature 18 specifically has a rectangular shaped body 20 with a first end 22 and a second end 24. The first end 22 is permanently fastened to a first portion 26 of well 14, which may be via a sill plate feature 28. The sill plate feature 28 additionally provides for the convenience of angular flexibility at the first end 22 when the tire-removal feature 18 is properly being used to raise tire 16 (discussed below). Fasteners (e.g., screws, industrial tacks, etc.) may also be incorporated at the first end 22 to ensure first end 22 remains permanently fastened to the first portion 26 throughout use of feature 18. The second end 24 is releasably fastened to a second portion 30 of well 14, which may be via a latch or slot (as shown) for comfort of release. Skilled artists will see that body 20 may include one or more openings to allow for tie-down bolts or other apparatus to extend through.

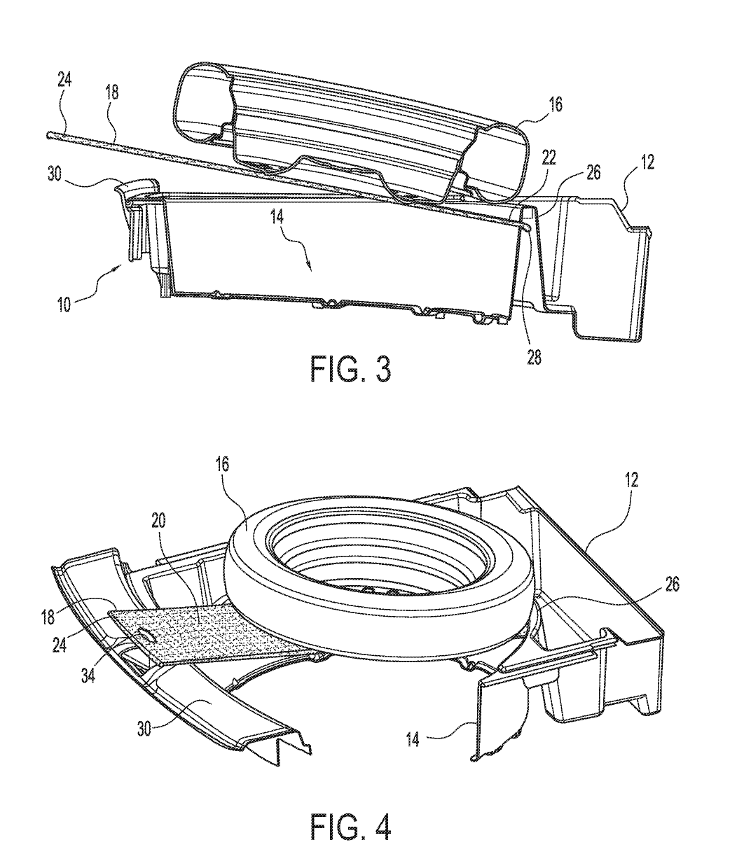

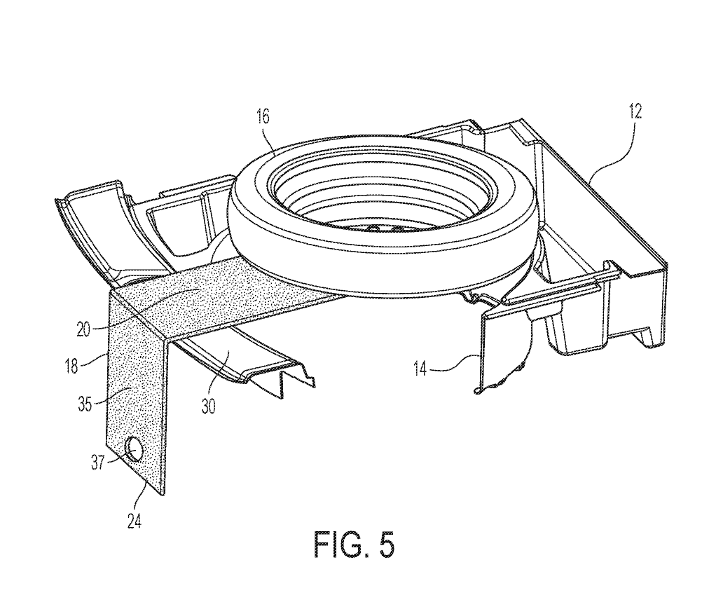

As shown in FIGS. 3 and 4, tire-removal feature 18 can raise tire 16 up and out of well 14. This can occur when a user 32 (FIGS. 5A and 5B) releases the second end 24 from it respective well portion 30 and then extends this second end 24 directly away from the first end 28, and its respective well portion 26, with such force that the body 20 of feature 18 becomes substantially inflexible. In other words, in this embodiment, the user pulls second end 24 towards themselves with enough strength to cause tire-removal feature 18 to become rigidly tight. To accomplish this effect, a handle 34 may be incorporated into body 20 to help extend second end 24 directly away from the first end 28.

Another embodiment of the tire-removal feature 18 is shown in FIG. 5. In this embodiment, second end 24 includes an extension section 35 which drapes over the second portion 30 of well 14 (and out of the vehicle trunk 12). Near the second end 24 (e.g., 2-5 inches away from its edge) is an opening that is adapted to receive the foot 39 of user 32. As such, tire-removal feature 18 can raise tire 16 up and out of well 14, while body 20 becomes substantially inflexible, when the user 32 has inserted their foot 39 into opening 37 and subsequently presses their foot 39 down using their bodyweight (i.e., extending second end away from the second portion 30). One or more rollers (not shown) may be incorporated onto the second portion 30 of well 14 to ease the raising of tire 16 out of well 14 after the user presses their foot 39 down with their bodyweight.

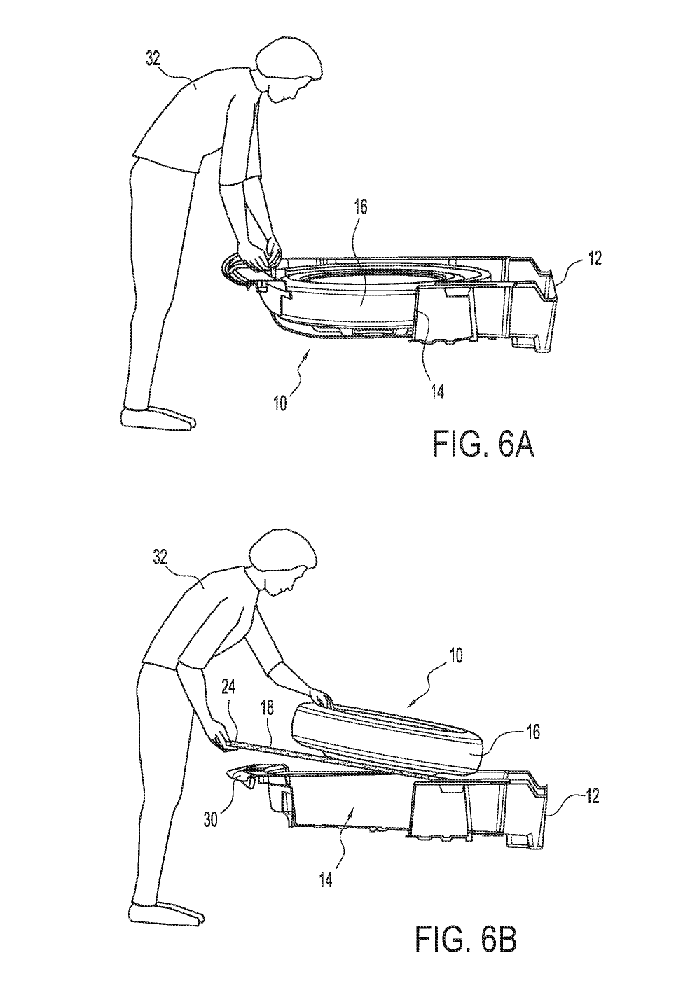

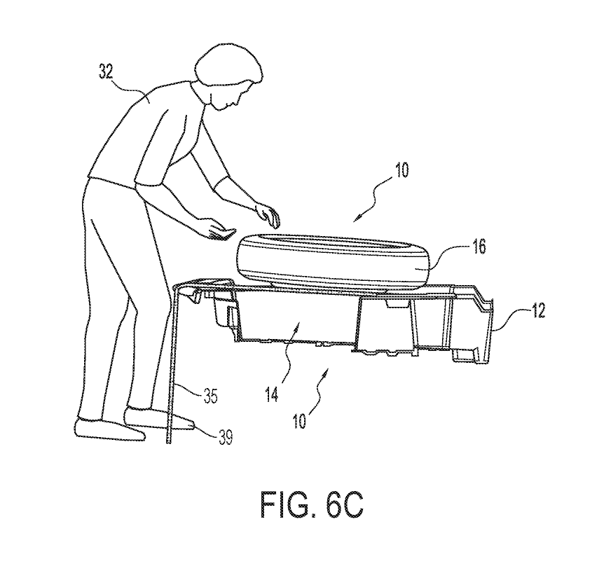

A method of using the vehicle tire removal system 10 can be seen in FIGS. 6A through 6C. As shown, in a first exemplary step, user 32 should simply release the second end 24 from second portion 30 of well 14. In a next exemplary step, user 32 should extend the second end 24 away from the second portion 30 of well 14. In a next exemplary step, user 32 should permit the body 20 of tire-removal feature 18 to become substantially inflexible by further extending the second end 24 away from the first end 22. For example, user 32 should pull the second end 24 towards their body (as shown in FIG. 5B). In another example, user 32 should insert their foot 39 into opening 37 and then apply their bodyweight by pressing their foot 39 downward (as shown in FIG. 5C). In a next exemplary step, tire 16 should raise from well 14 during this process; for instance, while body 20 becomes substantially inflexible. In a final, optional, step, user 32 may remove the raised tire 16 from feature 18 when its body 20 is substantially inflexible. As such, user 32 simply needs to grip tire 16 and either slide it off the rigid body 20 or pick the tire 16 up and off of the rigid body 20.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A tire-removal feature configured to be located within a tire well, the tire well configured to contain a vehicle tire, the tire-removal feature comprising:
a rectangular-shaped body approximately half the width of the vehicle tire, the rectangular-shaped body having a first end and a second end;
the first end configured to be permanently fastened to a first portion of the tire well;
the second end configured to be releasably fastened to a second portion of the tire well; and
wherein the tire-removal feature is configured to substantially remove the vehicle tire from the tire well by lifting the vehicle tire up and out of the tire well such that the vehicle tire is substantially parallel to the bottom surface of the tire well, when the second end is released and extended away from the second portion of the tire well such that the body becomes substantially inflexible.

2. The tire-removal feature of claim 1, wherein the tire-removal feature is configured to allow the vehicle tire to rest over the body when the second end is not being extended away from the second portion of the tire well.

3. The tire-removal feature of claim 1, wherein the body is made from a flexible material.

4. The tire-removal feature of claim 1, wherein the body is made from an elastomeric material, fabric, polyethylene, polypropylene, aluminum, copper, or some combination thereof.

5. The tire-removal feature of claim 1, wherein:
the application of the body weight of a human user facilitates the body to become substantially inflexible; and
the second end comprises an opening configured to receive the foot of the human user.

6. The tire-removal feature of claim 1, wherein the second end comprises a handle.

7. The tire-removal feature of claim 1, wherein the first end is configured for a sill plate feature to permanently fasten the first end to the first portion of the tire well.

8. A vehicle tire removal system, the system comprising:
a tire well configured to contain the vehicle tire within a vehicle;
a tire-removal feature having a rectangular-shaped body approximately half the width of the vehicle tire and located within the tire well, wherein a first end of the body of the tire-removal feature is permanently fastened to a first portion of the tire well and the second end of the body is releasably fastened to a second portion of the tire well, and wherein the tire-removal feature is configured to substantially raise the vehicle tire from the tire well such that the vehicle tire is substantially parallel to the bottom surface of the tire well when the second end is released and extended away from the second portion of the tire well such that the body of the tire removal feature has become substantially inflexible.

9. The system of claim 8, wherein the tire-removal feature is configured to allow the vehicle tire to rest over the body when the second end of the body is not being extended away from the second portion of the tire well.

10. The system of claim 8, wherein the body is made from an elastomeric material, fabric, polyethylene, polypropylene, aluminum, copper, or some combination thereof.

11. The system of claim 8, wherein the second end of the body comprises a handle.

12. The system of claim 8, wherein:
the second end is extended away from the second portion of the tire well through the implementation of the body weight of a human user; and
the second end comprises an opening configured to receive the foot of the human user.

13. The system of claim 8, wherein the tire well is located in the trunk of a vehicle.

14. The system of claim 8, wherein a sill plate feature permanently fastens the first end of the body to the first portion of the tire well.

15. A method of removing a tire from a tire well, the method comprising:
providing a tire well configured to contain a vehicle tire;
providing a tire-removal feature configured to be located within the tire well, the tire-removal feature comprising:
a rectangular-shaped body approximately half the width of the vehicle tire, the rectangular-shaped body having a first end and a second end;
the first end permanently fastened to a first portion of the tire well; and
the second end releasably fastened to a second portion of the tire well;
releasing the second end from the second portion of the tire well;
extending the second end away from the second portion of the tire well;
permitting the body to become substantially inflexible by further extending the second end away from the first end; and
allowing the vehicle tire to raise from the tire well such that the vehicle tire is substantially parallel to the bottom surface of the tire well while the body becomes substantially inflexible.

16. The method of claim 15, further comprising:
providing the vehicle tire configured to be contained in the tire well; and
removing the raised vehicle tire from the tire well when the body has become substantially inflexible.

17. The method of claim 15, further comprising allowing the vehicle tire to rest over the body when the second end is not being extended away from the second portion of the tire well.

18. The method of claim 15, wherein:
applying the body weight of a human user after inserting that user's foot into an opening formed at the second end of the tire-removal feature so as to raise the vehicle tire from the tire well while the body becomes substantially inflexible.

19. The method of claim 15, wherein the body is made from an elastomeric material, fabric, polyethylene, polypropylene, aluminum, copper, or some combination thereof.

20. The method of claim 15, wherein the first end is configured for a sill plate feature to permanently fasten to the first end to the first portion of the tire well.
